(19) United States
(12) Patent Application Publication
(10) Pub. No.: US 2011/0052364 A1
(43) Pub. Date: Mar. 3, 2011

(54) apparatus and method for handling railway rails

(75) Inventor: William Francis McCulloch, Girvan (GB)

(73) Assignee: W & D McCulloch, Ballantrae, Girvan (GB)

(21) Appl. No.: 12/682,723

(22) PCT Filed: Oct. 13, 2008
(86) PCT No.: PCT/GB2008/003461

§ 371 Date: Jun. 9, 2010

(30) Foreign Application Priority Data
Oct. 17, 2007 (GB) 0720303.7

(51) Int. Cl. E01B 29/17; B60P 3/40

(52) U.S. Cl. 414/800; 104/2

(57) ABSTRACT

An apparatus for handling railway track components has a self-propelled vehicle with ground-engaging rolling means spaced either side of a working space and a load-bearing platform adapted for spanning the working space so as to support a part of a load being transported using the self-propelled vehicle.

The invention relates to the handling of railway (railroad) rails, railway switch components, panels and the like, for the installation and replacement of railway infrastructure.

Various specialised machines have been developed over many years to assist in the installation of railways. Some of these machines are vehicles designed can run alternatively on road and rail, having alternate wheels for each mode. Other machines, including very large and heavy machines, run on rail only. Lifting machines are also known which can span a whole rail track, running on “caterpillar” type tracks on the ballast either side of the railway. In the course of installing or renewing a railway, there may be a need to manoeuvre lengths of steel rail from tens of metres to hundreds of metres in length. Also there may be a need to manoeuvre more awkward-shaped panels of rail and bearer combined, and components of switch points and other types of junction.

To assist in this, machines have evolved with specialised functions. Machines which are larger and more specialised may be able to complete certain tasks very efficiently. However, they are more expensive in capital terms, and they can impose great disruption on the rail network, in obtaining access and space to work. To work with machines which have above a certain height or reach, for example, it will be necessary to close neighbouring tracks and/or to isolate electric overhead lines. Many lifting machines are designed to work on one track while riding on an adjacent track. Naturally this disrupts traffic on the adjacent track, and also prevents the application of these machines to single-track projects.

Using conventional methods and equipment, therefore, there is often a great deal of disruption incurred to effect even relatively small engineering works, and/or the works take more time or money than one would like, because of the pressure to avoid disruption.

In WO 05/095716 A1, the present applicant disclosed a compact, low-cost machine for performing transposition of a very long length of continuous welded rail from a track-side to its location on the bearers (sleepers). The machine is compact yet powerful, by virtue of the fact that the load-bearing parts are located within the footprint of its ground-engaging wheels or tracks. The machine can operate in locations and in windows of opportunity unavailable to conventional techniques. The present invention in its various aspects aims to bring similar benefits to other tasks.

The invention in a first aspect provides apparatus for handling railway track components, the apparatus comprising a self-propelled vehicle having ground-engaging rolling means spaced either side of a working space and a load-bearing platform adapted for spanning said working space so as to support a part of a load being transported using said self-propelled vehicle.

The load-bearing platform may be mounted on the vehicle so as to permit rotation of the platform and load for steering the vehicle.

The load-bearing platform is preferably mounted on the vehicle so as to permit sliding of the platform relative to the vehicle in a direction of travel (referred to hereinafter as the longitudinal direction) to absorb differences in speed of vehicle and load. The vehicle will typically be used in pairs or larger gangs, each vehicle adjusting its speed and steering independently, though in co-ordinated fashion. The sliding and rotating of the platform facilitate this.

The apparatus may further comprise an elevated chassis joining the ground-engaging rolling means above said working space.

The apparatus may further include a hoist mounted on said elevated chassis for lowering and lifting a load on and off said platform.

The platform is preferably mounted to be movable from the vehicle in a direction transverse to the direction of travel, so as to permit lifting and lowering of said load from a position on the ground to a position above the level of the platform.

The platform may be provided with adjustable restraining elements to restrict sliding of a load in a direction transverse to the direction of travel of the vehicle.

The ground-engaging rolling means may comprise continuous tread tracks running substantially the length of the vehicle at each side.

The ground-engaging rolling means may alternatively comprise wheels.

The vehicle may optionally be provided with rail wheels deployable to support the vehicle and load in a journey along a rail track.

The apparatus is preferably less than 2.5 m, more preferably less than 2 metres, in one or more of height, width and length. The apparatus is preferably less than 2 metres in each dimension.

The width between the ground-engaging rolling means is preferably such that the vehicle can straddle one rail but not both rails of a Standard Gauge railway. The width between the ground-engaging rolling means may be approximately the same as the Standard Gauge rail spacing (1435 mm inside spacing).

The invention in another aspect provides a load-bearing accessory for a railway maintenance vehicle, the accessory comprising: a supporting member for spanning a working space between two laterally spaced supports; and a platform rotatably coupled to the supporting member so as to provide support for a load whose orientation relative to the supports may vary.

The supporting member and platform may each comprise a metal beam.

The supporting member may be provided at each end with a wing portion adapted to lie on top of said supports and slide in a longitudinal direction relative to the supports.

The platform may be provided with restraining elements for restricting lateral movement of a load resting on the platform.

The restraining elements may be adjustable in position.

The supporting member may be adapted to span a gap of 900-1500 mm width between said supports, preferably 900-1100 mm.

The invention in yet another aspect provides a method of transporting railway rail or rail track components in the vicinity of a railway undergoing construction or refurbishment, the method comprising:
providing at least two self-propelled vehicles, each vehicle having a working space between spaced-apart ground-engaging rolling means and means for supporting a load at a point within the footprint of said ground-engaging rolling means;
supporting a portion of rail or other elongate load partially on the load-supporting means of each vehicle; and
driving and steering the vehicles in a co-ordinated manner to transport the load to a desired location in the vicinity of the railway.

The load-supporting means of at least one vehicle may comprise a hoist suspended from an elevated chassis bridging the spaced-apart ground-engaging rolling means of the vehicle.

The load-supporting means of at least one vehicle may comprise a load-bearing platform mounted on the vehicle and bridging the spaced-apart ground-engaging rolling means.

The load-bearing platform may be arranged to permit rotation of the platform and load while steering the vehicle and load along a curved path.

The load-bearing platform may be mounted on the vehicle so as to permit sliding of the platform relative to the vehicle in a direction of travel (referred to hereinafter as the longitudinal direction) to absorb differences in motion between vehicle and load.

The vehicle having the load-bearing platform may further comprise an elevated chassis joining the ground-engaging rolling means above said working space.

The apparatus may further include a hoist mounted on said elevated chassis for lowering and lifting a load on and off said platform.

The platform may be mounted to be removable from the working space in a direction transverse to the direction of travel, so as to permit lifting and lowering of said load from a position on the ground to a position above the level of the platform.

The platform may be provided with adjustable restraining elements to restrict sliding of a load in a direction transverse to the direction of travel of the vehicle.

The ground-engaging rolling means may comprise continuous tread tracks running substantially the length of the vehicle at each side.

The ground-engaging rolling means may alternatively comprise wheels.

At least one vehicle may optionally be provided with rail wheels deployable to support the vehicle and load in a journey along a rail track.

The method may include driving the vehicles over a rail track from a track-side location.

The method may include driving the vehicles and load through a gap between trackside obstacles such as power line pylons.

The method may include more than three vehicles supporting a length of rail more than 100 m long.

Such a method may included driving and steering the vehicles so as to bend the rail through a gap between track-side obstacles such as power line pylons.

In a preferred embodiment, each vehicle is less than 2.5 m, more preferably less than 2 metres, in one or more of height, width and length. The vehicle is preferably less than 2 metres in each dimension.

The width between the ground-engaging rolling means is preferably such that the vehicle can straddle one rail but not both rails of a Standard Gauge railway. The width between the ground-engaging rolling means may be approximately the same as the Standard Gauge rail spacing (1435 mm inside spacing).

### BRIEF DESCRIPTION OF THE DRAWINGS

Embodiments of the invention will now be described, by way of example only, by reference to the accompanying drawings, in which:

FIG. 1 is a side view of a known track rail transposer machine;

FIG. 2 shows the track rail transposer machine in a longitudinal view, handling a rail;

FIG. 3 is a plan view of a rail transposing operation performed using the machine in FIGS. 1 and 2;

FIGS. 4 and 5 are side and longitudinal views of the same machine being used for transporting rails;

FIG. 6 is a plan view of several machines transporting a length of continuous welded rail;

FIGS. 7 and 8 are side and plan views of the sliding turntable accessory for use with the machine on FIGS. 1 to 6;

FIG. 9 is a cut-away plan view of the accessory of FIGS. 7 and 8 mounted on the machine;

FIG. 10 is a longitudinal view of the machine and turntable accessory carrying a track junction component;

FIG. 11 is a plan view of two machines with turntable accessories carrying the track junction component to or from its intended location;

FIG. 12 is a side view of a machine modified to include rail wheels in addition to ground-engaging tracks;

FIG. 13 is a longitudinal view of the modified machine riding on rails and carrying a track junction component; and

FIG. 14 shows two of the modified machines carrying the track junction component on the rail wheels, being towed behind a conventional road/rail vehicle.

### DETAILED DESCRIPTION OF THE EMBODIMENTS

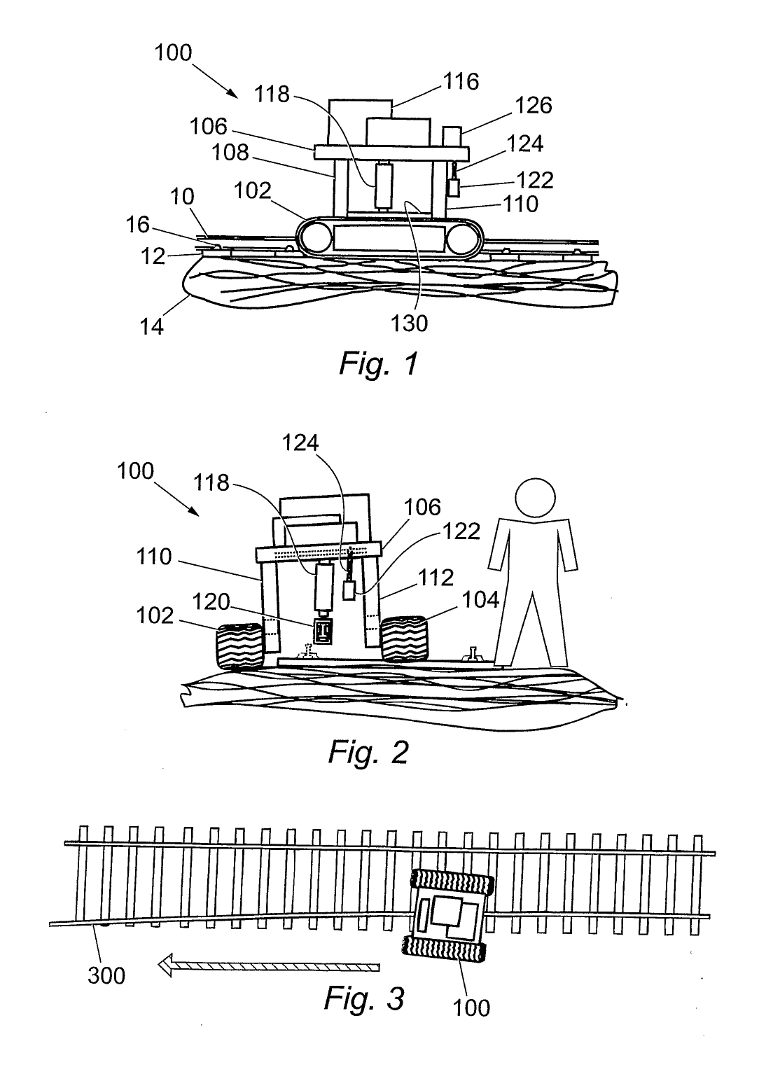

The apparatuses and methods to be described herein are generally used in the installation, maintenance and repair of railway (railroad) infrastructure. Referring to FIG. 1 of the drawings, typical railway comprises two or more lengths of steel rail 10 mounted on bearers (sleepers) 12, laid along prepared bed of ballast 14 or concrete ground. The rail 10 historically would be formed of short sections carried to the site and lifted into place by machines and/or men, and joined by fishplates and so forth. In more modern times, particularly for high speed rail traffic, continuous welded rail (CWR) is used, which can be delivered to the work site from the steel works in lengths of over 200 metres. The rails 10 are fixed to the sleepers in chairs 16. The skilled person will understand that many different forms of bearer, supporting ground, rail and chair or other fixing are available and suitable for use in different applications. The illustration or mention of any particular form of rail, bearer, chair etc. in the present description is merely to serve as an example, without any limitation as to the field of application of the apparatus and processes described herein.

WO 05/095716 A1 of the present applicant describes the “track rail transposer” (TRT) machine which can be seen in FIG. 1 and in the longitudinal view of FIG. 2. The machine is self-propelling, by means of motorised tracks 102, 104. The width between the track centres is in this example roughly the same as the space between the rails of the railway (the gauge), for example 1.4 metres. The overall footprint of the machine is roughly square, with dimension 1.7 metres long by 1.7 metres to the extremity of the tracks. The machine chassis 106 is supported just over a metre above the ground on four legs 108 to 114. (Leg 114 is not visible in these views). On top of the chassis are mounted a power source such as a diesel motor, and associated fuel tank, hydraulic pumps and control systems. Housings for these works are indicated generally at 116.

As seen in FIG. 2, the TRT machine is of a scale similar to a human operator, being less than 2 metres, certainly less than 2.5 metres high in total. Load bearing components are carried beneath chassis 106 in the working space, roughly a 1 metre cube, between the legs 108 to 114. As the machine moves in the course of its operations, this working space may be above ground beside the track, on the track-side ballast, or directly above the bearers. The small dimensions of the machine do not permit it to straddle the entire Standard Gauge rail pair, but rather to straddle one rail or rail bed at a time. As explained in the prior patent application, the fact that loads are supported always within the footprint of the tracks 102, 104, it can be of compact size and light weight, in particular because there is no need for counterweights to balance an off-set load. By its small size, many advantages are gained, while the machine is capable of several different operations to be described further below, which traditionally would be undertaken by very large numbers of men (in developing countries) or by very large and very expensive machinery in more developed countries. The small size of the machine allows operations to be performed with minimal disruption to the regular running of the rail network, either in terms of isolation of overhead supplies or of blocking the traffic on neighbouring tracks. The small size of the machine also allows it to be transported to relatively inaccessible locations, for example, in the back of a small truck or van. Access through roads and tracks allows the machine to operate on single track railways, as it does not require an adjacent track to gain access to its working location.

The type of operation specifically described in WO 05/095716 A1 is that of transposing a length of continuous welded rail from a location at the side of a track onto its operating location, and the reverse operation of removing an existing rail for replacement. For this purpose, the TRT machine 100 is provided with two primary accessories, both supported from the chassis. The first accessory is a transposing arm 118 which is extendable and pivotally mounted beneath the centre of the chassis, and carries a transposing head 120. The pivot mounting at the top of the arm 118 is optionally motorised to drive it from side to side within the chassis. The transposing head comprises a metal device for surrounding a rail, shown in FIG. 2, and containing rollers to restrain the rail in vertical and lateral directions as it slides through the head 120 in the longitudinal direction. An opening gate allows the rail to be inserted and removed laterally from the transposing head 120, it being possible also to thread the rail longitudinally without opening the gate. The other accessory hanging from the chassis is a hoist with rail gripper 122 depending from a variable length of chain 124, which can either passively or actively be driven along transverse tracks, and is powered by a motorised or manually operated winch in housing 126.

With a length of rail being transposed being loaded into the transposing head 120 using the winch and gripper 122 as shown in FIG. 2, FIG. 3 illustrates the transposing process by which a length of continuous welding rail is eased from a location where it has been deposited beside the track by a special freight train, to a location on the bearers, where it can be fixed in shoes and the railway very quickly returned to operation. This operation, described already in WO 05/095716 A1, simply involves the TRT machine motoring along the track and moving its transposing head along the length of the rail, while being steered to apply a transverse force to progressively end the rail and deposit it along the desired line. The process can be reversed to remove an existing rail. Experience has shown that the TRT machine is able to remove and replace rail extremely quickly and efficiently, minimising disruption to the rail service and with minimal capital expenditure.

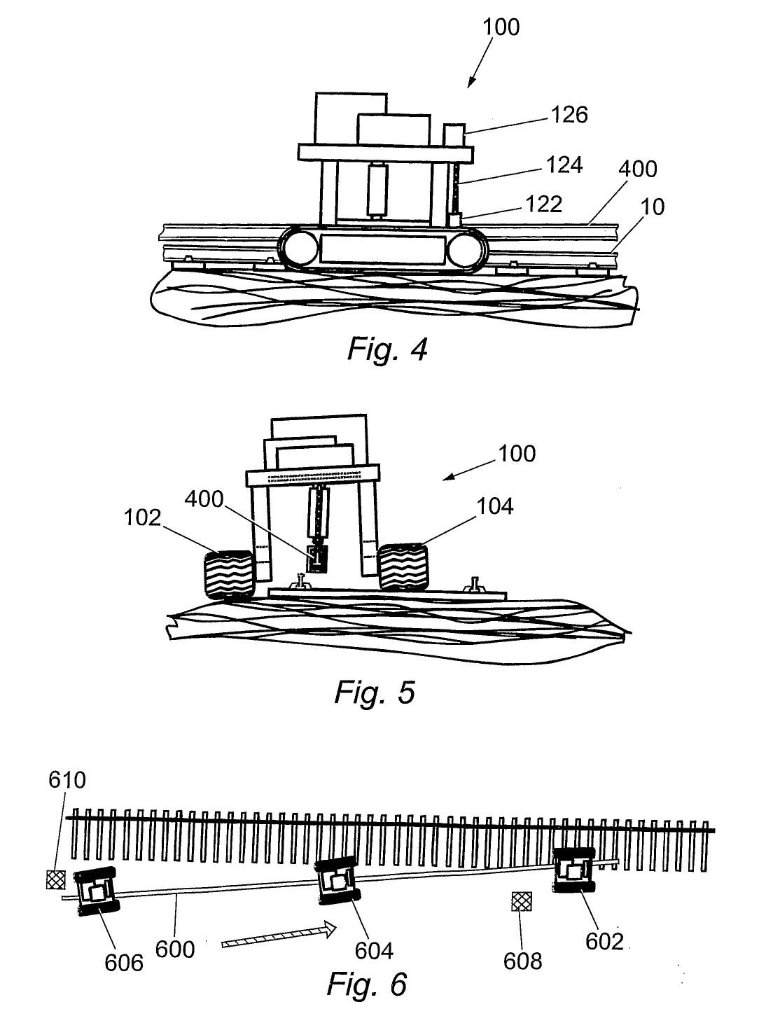

FIGS. 4 onwards describe different modes of operation that are performable with the TRT machine. These operations may be performed also with a machine of similar proportions that may not be provided with the transposing arm and head 120, if transposing operations are not required. Nevertheless it is advantageous if the same machine can serve multiple functions.

FIGS. 4 to 6 illustrate the use of the machine 100 in gangs of two or more to transport rails and other elongate loads bodily both transversely and along the track, if desired. FIGS. 4 and 5 show how the hoist and gripper 122 of each machine engage the rail and restrain it against longitudinal movement. The rail 400 may also, for added support and control, pass through the transposing head 120. As an alternative to using the gripper 122, some locking mechanism could be provided on the transposing head itself, but the chain 124 of the hoist provides a useful degree of longitudinal movement to be permitted, and thereby limits the risk of damaging forces being applied either to the rail or the machine.

FIG. 6 illustrates how a number of TRT machines can be used to manipulate a single piece of rail. In the case of a short piece of rail, for example 20 metres in length, it is a simple matter for two TRT machines to pick it up, one at either end, and carry it along a track, onto a track and so forth, to and from a storage location. FIG. 6 in particular illustrates, though not to scale, an operation in which a very long length of continuous welding rail 600, for example over 200 metres in length, may be carried by a gang of machines 602, 604 and 606. In practice, as many as 8 machines might be provided along such a length of rail 600. Each machine is provided with its own controls and human operator (not shown) who both drives and steers it by operation of hydraulic motors driving the tracks 102, 104. A unique feature of this method of transporting long rails is the ability of the machines to be steered so as to bend and guide the rail 600 through the gap between obstructions such as overhead power pylons 608, 610, which are a feature of many railways. It will be appreciated that these obstacles are spaced closer together than the length of the rail, making the task of moving the rail onto the track seemingly impossible with existing equipment. In current practice, such obstructions often result in the rail being cut into shorter lengths for transport onto the bearers, which naturally reduces the quality of the rail, and increases the delay and expense caused by the replacement operation.

In addition to single lengths of rail, bulkier items such as components of switch points and other types of track junctions and ancillary equipment also need to be manoeuvred on an off the railway. Conventionally, different sizes of crane may be required, including very large gantry cranes that may travel on tracks spanning the whole railway. For that purpose, a complete junction or section of track may be supplied as a “panel” integral with its bearers, and carried to the location. As mentioned already, such large machines are expensive to provide and operate, and their large size means that repair and replacement operations are very disruptive of the railway operations, and access to awkward sites and single-track railways may be impossible.

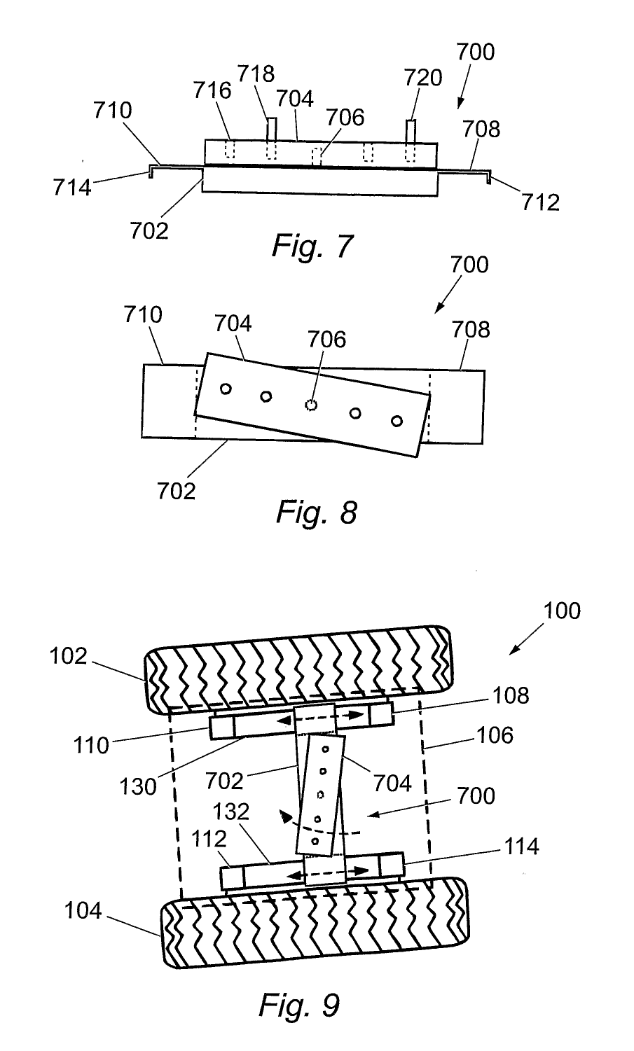

FIGS. 7 and 8 illustrate a turntable accessory 700 which has been devised to allow the TRT machines 100 to serve also in the carrying of switch components and the like onto and along a railway. Referring to the side view of FIG. 7, the turntable accessory comprises a main support beam 702 and a rotating platform 704 mounted on top of beam 702 by means of a pivot 706. Each of the pieces 702, 704 can be a section of steel box girder, for example. At each end of the supporting beam 702, a wing portion 708, 710 is provided with a down-turned end 712, 714 respectively. In the top side of the rotating platform 704, a number of blind recesses 716 are provided, and these allow a couple of restraining pins 718, 720 to be inserted at different locations, for restraining a load against transverse movement. As seen in the plan view of FIG. 8, the beam that is the rotating platform 704 can rotate about the pivot pin 706, so that it is not necessarily parallel to the supporting beam 702.

FIG. 9 is a plan view of a TRT machine of the type already described, with its chassis 106 and all the works supported on the chassis removed for a clear view of the working area beneath the chassis. The four legs 108 to 114 can be seen in cross-section, as well as two support beams 130 and 132 which extend in a longitudinal direction, parallel to each of the tracks 102, 104, either side of the working space. The turntable accessory 700 is dimensioned so that its support beam 702 can sit between the beams 130, 132 with its wing portions 708, 710 supporting the accessory on the beams 130, 132, and restrained against rotation and transverse displacement by the hook portions 712, 714. Accordingly, as seen in FIG. 9, the accessory 700 provides a platform 704 at the lower part of the working space of the machine 100, which can not only rotate, but also slide relative to the vehicle, by distance corresponding roughly to the forward/rear distance between the legs 108, 110. This permits the machine 100 to support a load such as a switching component and to transport it in cooperation with one or more similar machines, the sliding and rotating platform allowing the machine to adjust its position and orientation relative to the load during the course of its manually controlled operations.

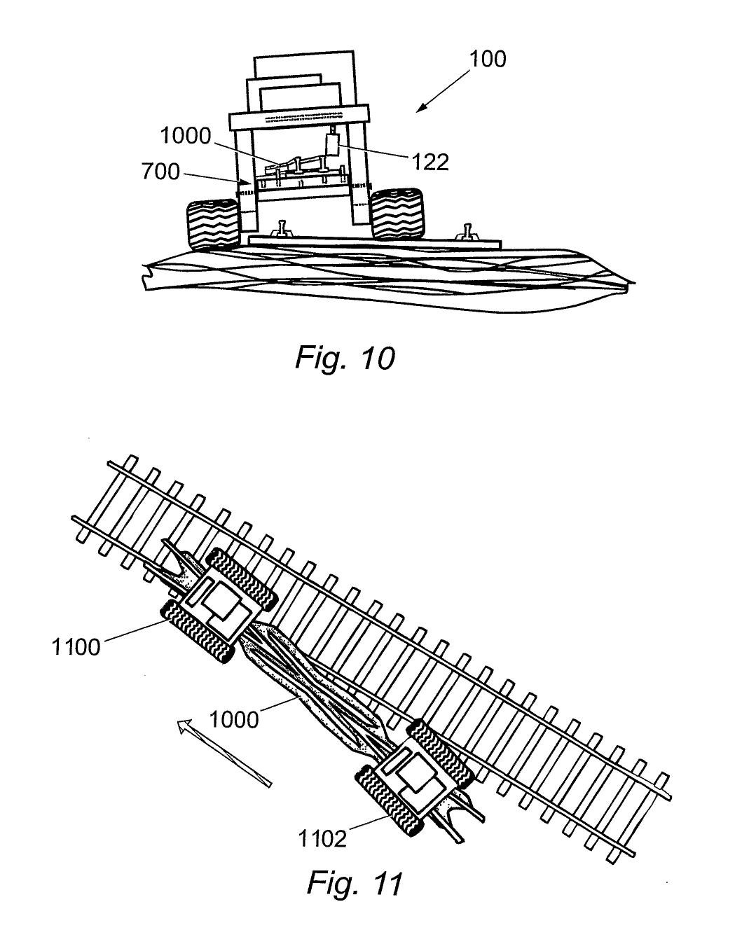

FIG. 10 is a longitudinal view of the machine performing such an operation to carry a load 1000. The transposing arm 118 and head 120 are shown removed for this operation, although they may in practice simply be stowed out of the way. Hoist and gripper are shown not in use although they may also be used to stabilise the load.

The load 1000 in this instance is a section of a track junction or similar panel, which rests on the turntable accessory and is restrained at suitable points by the inserted pins 718, 720. To mount the load on the turntable accessory, the vehicle 100 is manoeuvred over the load, with the accessory 700 removed. The hoist 126 and gripper 122 is used (or an independent hoist where available) to raise the load above the level of the turntable platform, and the accessory 700 is fitted across beams 130, 132 beneath the load. The load is then lowered onto the platform 704 using the hoist. The operation can be reversed to drop the load at its destination, that is by raising the load with the hoist, removing the accessory 700 from the working space and lowering the load to the ground.

FIG. 11 shows in plan view how two vehicles 1100, 1102 can be used in the manner shown in FIG. 10 to transport a crossing component along the ground and along the railway. The turning and sliding movements of the accessory 700 on each machine allow the human operators (not shown) to drive and steer the machines 1100, 1102 independently, but in a coordinated fashion, to carry the component 1000 from a delivery location to its installation location, or vice versa. The load is loaded onto and off the machines by performing the hoist operations just described with reference to FIG. 10 at both machines, either sequentially or in parallel.

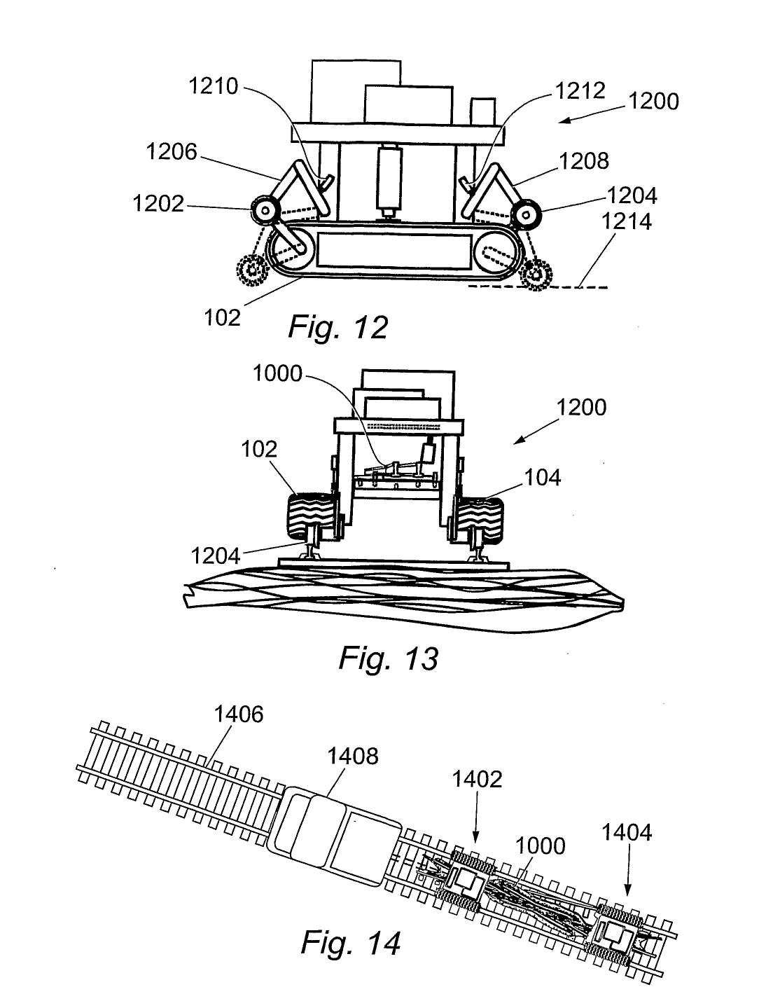

FIGS. 12 to 14 show a modified TRT machine 1200, in which the same components are recognisable as in the machine 100 of FIG. 1 but there are additionally provided pairs of rail wheels 1202, 1204. The rail wheels can be deployed or retracted, so that the machine has the option, like a road/rail vehicle, to ride on the ground or along the railway in the manner of a train. Linkages 1206 and 1208 are driven by manual or hydraulic jacks 1210, 1212, so that the wheels 1202, 1204 can be moved from their stowed position, shown in solid lines in FIG. 12, to their operational position, shown in dotted lines. In their operational position, the bearing surfaces of the rail wheels are at a level 1214 just below the lower portion of the ground-engaging tracks 102, 104.

As seen in the longitudinal view of FIG. 13, the wheels 1202, 1204 in their deployed position allow the apparatus 1200, and any load 1000 which it is carrying to run along an existing railway. The rail wheels 1202, 1204 may be powered by hydraulic motors, or may be passive, so that the machine is simply pushed or pulled by another vehicle or human operator.

FIG. 14 shows, as one example, a plan view of two of the modified vehicles 1402, 1404 being towed along a rail track 1406 by a road/rail truck 1408. The load 1000 is again carried between the apparatuses, which have their rail wheels 1202, 1204 deployed beneath them, so as to run along the track. Towing linkages 1410 and 1412 may be either rigid or flexible. While the machines 1402/1404 may be able to propel themselves along the ground on their tracks 102, 104 at a speed corresponding to a brisk walking pace (say 5 kmh-10 kmh) deployment of the rail wheels 1202, 1204 may allow a faster transit along the railway, for example at speeds in the range 20-30 kmh.

The road/rail vehicle 1408 may be of conventional type, including a load space for tools and accessories, as well as a cabin for the crew required to perform the various operations on site.

The above and other modifications of the apparatus and methods can be made within the spirit and scope of the invention.

1-43. (canceled)

44. An apparatus for handling railway track components, the apparatus comprising a self-propelled vehicle having ground-engaging rollers disposed on either side of a working space, and a movable load-bearing support member deployable to span said working space so as to support at least part of a load being transported using said self-propelled vehicle, wherein the load-bearing support member when deployed is mounted on the vehicle so as to permit rotation of the support member and the load for steering the vehicle, and to permit sliding of the support member relative to the vehicle in a direction of travel of the vehicle.

45. The apparatus of claim 44, wherein the load-bearing support member is removable from the apparatus.

46. The apparatus of claim 44, wherein the load-bearing support member is provided with adjustable restraining elements to restrict sliding of the load in a direction transverse to the direction of travel of the vehicle.

47. The apparatus of claim 44, wherein the ground-engaging rollers comprise continuous tread tracks running substantially the length of the vehicle.

48. The apparatus of claim 44, wherein the ground-engaging rollers comprise wheels.

49. The apparatus of claim 44, wherein the vehicle is provided with rail wheels deployable to support the vehicle and load for movement along a rail track.

50. The apparatus of claim 44, wherein the apparatus is less than 2.5 meters in at least one of height, width, and length.

51. The apparatus of claim 44, wherein the apparatus is less than 2 meters in at least one of height, width, and length.

52. The apparatus of claim 44, wherein the apparatus is less than 2 meters in each of height, width, and length.

53. The apparatus of claim 44, wherein the width between the ground-engaging rollers is such that the vehicle can straddle one rail but not both rails of a Standard Gauge railway.

54. The apparatus of claim 44, wherein the width between the ground engaging rollers is approximately the same as the standard gauge rail spacing (1435 mm inside spacing).

55. A load-bearing accessory for a railway maintenance vehicle, the accessory comprising:
a supporting beam for spanning a working space between two laterally spaced supports; and
a load-bearing support member rotatably coupled to the supporting beam so as to provide support for a load whose orientation relative to the supports may vary, wherein the supporting beam is provided at each end with a wing portion adapted to lie on top of said supports and slide in a longitudinal direction relative to the supports while being restrained by the supports in a lateral direction.

56. The load-bearing accessory of claim 55, wherein the supporting beam and load-bearing support member each comprise a metal beam.

57. The load-bearing accessory of claim 55, wherein the load-bearing support member is provided with restraining elements for restricting lateral movement of a load resting on the load-bearing support member.

58. The load-bearing accessory of claim 57, wherein the restraining elements are adjustable in position.

59. The load-bearing accessory of claim 55, wherein the supporting beam is adapted to span a gap of approximately 900-1500 mm width between said supports.

60. The load-bearing accessory of claim 55, wherein the supporting beam is adapted to span a gap of approximately 900-1100 mm width between said supports.

61. A method of transporting railway rail in the vicinity of a railway undergoing construction or refurbishment, the method comprising:
providing at least two self-propelled vehicles, each vehicle having a working space between spaced-apart ground-engaging rollers disposed at either side of a working space, and a movable load-bearing support which supports a load at a point within the footprint of said ground-engaging rollers;
supporting a portion of rail using the load-bearing support member of each vehicle; and
driving and steering the vehicles in a coordinated manner to transport the load to a desired location in the vicinity of the railway;
wherein the load-bearing support member is arranged to permit rotation of the load while steering the vehicle and load along a curved path; and
wherein the load-bearing support member is mounted on the vehicle so as to permit sliding of the load relative to the vehicle in a direction of travel to absorb differences in speed of the vehicle and the load.

62. The method of claim 61, wherein the load-bearing support member of at least one of the vehicles comprises a hoist suspended from an elevated chassis bridging the spaced-apart ground-engaging rollers of that vehicle, and the load is a section of rail without bearers suspended from the hoist of each vehicle during said transport.

63. The method of claim 61, wherein the load-bearing support member of at least one of the vehicles comprises a load-bearing support mounted on that vehicle and bridging the spaced-apart ground-engaging rollers.

64. The method of claim 63, wherein the vehicle having the load-bearing support further comprises an elevated chassis joining the ground-engaging rollers above said working space.

65. The method of claim 64, wherein the vehicle further includes a hoist mounted on said elevated chassis for lowering and lifting a load on and off said load-bearing support.

66. The method of claim 65, wherein the load-bearing support is mounted to be removable from the working space in a direction transverse to the direction of travel, the method including removing the load-bearing support while moving said load between a position on the ground and a position above the level of the load-bearing support using said hoist, the load being supported, whether by the hoist or by the load-bearing support, within a footprint of the ground-engaging rollers on the ground.

67. The method of claim 63, wherein the load-bearing support is provided with adjustable restraining elements to restrict sliding of a load in a direction transverse to the direction of travel of the vehicle.

68. The method of claim 61, wherein the ground-engaging rollers of at least one of the vehicles comprise continuous tread tracks running substantially the length of the vehicle.

69. The method of claim 61, wherein the ground-engaging rollers of at least one of the vehicles comprise wheels.

70. The method of claim 61, wherein at least one of the vehicles is provided with rail wheels deployable to support that vehicle and a load for movement along a rail track.

71. The method of claim 61, further comprising driving the vehicles over a rail track from a track-side location.

72. The method of claim 61, further comprising driving the vehicles and load through a gap between trackside obstacles.

73. The method of claim 61, wherein the method includes more than two vehicles supporting a length of rail more than 100 meters long.

74. The method of claim 73, further comprising driving and steering the vehicles so as to bend the rail through a gap between track-side obstacles.

75. The method of claim 61, wherein at least one of the vehicles is less than 2.5 meters in at least one of height, width, and length.

76. The method of claim 61, wherein at least one of the vehicles is less than 2 meters in at least one of height, width, and length.

77. The method of claim 61, wherein at least one of the vehicles is less than 2 meters in each of height, width, and length.

78. The method of claim 61, wherein the width between the ground-engaging rollers is such that at least one of the vehicles can straddle one rail but not both rails of a Standard Gauge railway.

79. The method of claim 61, wherein the width between the ground engaging rollers of at least one of the vehicles is approximately the same as the inside spacing of a Standard Gauge railway.

80. An apparatus for handling railway track components, the apparatus comprising a self-propelled vehicle having ground-engaging rollers disposed at either side of a working space, an elevated chassis joining the ground-engaging rollers above said working space, and a hoist mounted on said elevated chassis for lowering and lifting a load to be carried by the apparatus in a direction of travel of the vehicle, and a movable load-bearing support member deployable to span said working space at a level below the hoist so as to support a part of a load being transported using said self-propelled vehicle whereby said hoist can be used for lifting and lowering of said load between a position on the ground and a position above the level of the load-bearing support member while the load-bearing support member is removed from the working space, and for lifting and lowering of the load onto and off of the load-bearing support member when the load-bearing support member is deployed, the load being supported at all times within a footprint of the ground-engaging rollers on the ground.

81. The apparatus of claim 80, wherein the load-bearing support member is removable from the apparatus.
